(19) United States
(12) Patent Application Publication
(10) Pub. No.: US 2022/0245867 A1
(43) Pub. Date: Aug. 4, 2022

(54) SIMULTANEOUS CT SCANNING AND RECONSTRUCTION

(71) Applicant: James R. Glidewell Dental Ceramics, Inc., Newport Beach, CA (US)

(72) Inventor: Fedor Chelnokov, Khimki (RU)

(21) Appl. No.: 17/162,833

(22) Filed: Jan. 29, 2021

(51) Int. Cl. G06T 11/00; G06T 7/60

(52) U.S. Cl. CPC G06T 11/005; G06T 11/008; G06T 2210/52; G06T 2207/10081; G06T 7/60

(57) ABSTRACT

A computer-implemented method and system for CT reconstruction can include receiving a plurality of detected radiographs from a CT scanner during CT scanning and beginning reconstruction of one or more of the detected radiographs before all of the detected radiographs are acquired.

### BACKGROUND

A computed tomography scan (“CT scan”) typically involves placing a physical object on a rotating platform inside a CT scanner between an x-ray source and x-ray detector and rotating the object around an axis of rotation to generate radiographs from the x-rays detected by the detector. Conventionally, the radiographs can be tomographically reconstructed into a 3D representation of the object scanned (“CT reconstruction”). One example of CT reconstruction can be found in, for example, in the publication Principles of Computerized Tomographic Imaging (A. C. Kak and Malcolm Slaney, Principles of Computerized Tomographic Imaging, IEEE Press, 1988), the entirety of which is hereby incorporated by reference. Other types of CT reconstruction can also be performed.

CT scanning conventionally involves first acquiring all radiographs (also known as projection images) from a CT scan and storing the radiographs in storage such as a computer hard drive or other storage media. After the CT scan of the object is complete and all radiographs are acquired, software then loads the radiographs from the storage media and performs CT reconstruction on all of the acquired radiographs to generate the 3D representation as a volumetric density file. CT reconstruction thus does not begin until after CT scanning is complete, and after all of the radiographs have been acquired and stored in storage media. This can significantly delay reconstruction and generation of the final reconstructed volumetric image until after the CT scanning finishes acquiring all of the radiographs.

### SUMMARY

A computer-implemented method for CT reconstruction can include receiving a plurality of detected radiographs from a CT scanner during CT scanning and beginning reconstruction of one or more of the detected radiographs before all of the detected radiographs are acquired.

A system for CT reconstruction can include a processor, a computer-readable storage medium comprising instructions executable by the processor to perform steps including: receiving a plurality of detected radiographs from a CT scanner during CT scanning; and beginning reconstruction of one or more of the detected radiographs before all of the detected radiographs are acquired.

### BRIEF DESCRIPTION OF THE DRAWINGS

FIG. 1 is a schematic diagram of a computed tomography (CT) scanning system.

FIG. 2 is a 2-dimensional (2D) radiographic image of a dental impression tray containing a dental impression.

FIG. 3 is a cross-section of a 3-dimensional (3D) volumetric image.

FIG. 4 is a schematic diagram of a CT scanning system.

FIGS. 5(a)-5(c) are radiographic image examples.

FIG. 6 is a schematic diagram of an example of conventional back projection.

FIG. 7 is a flow chart showing an example of conventional CT scanning and reconstruction.

FIG. 8 is a flow chart of an example of CT scanning and reconstruction in some embodiments.

FIG. 9 is a flow chart of an example of CT scanning and reconstruction in some embodiments.

FIG. 10 is a flow chart of an example of CT scanning and reconstruction in some embodiments.

FIG. 11 is a schematic diagram of an example of a processing system in some embodiments.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

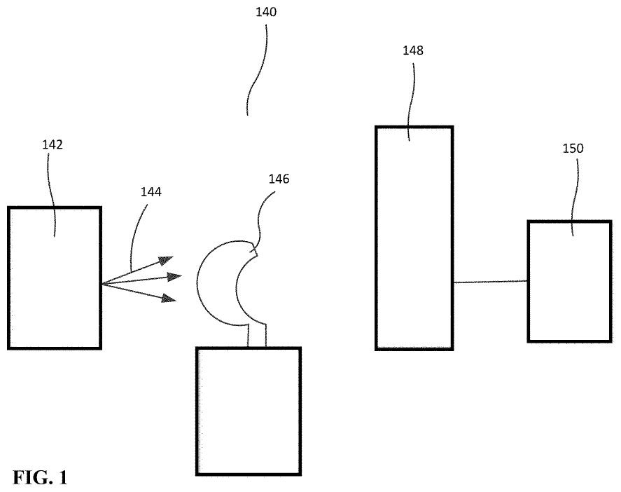

In one embodiment of the present disclosure, a computed tomography (CT) scanner uses x-rays to make a detailed image of an object. A plurality of such images are then combined to form a 3D model of the object. A schematic diagram of an example of a CT scanning system 140 is shown in FIG. 1. The CT scanning system 140 includes a source of x-ray radiation 142 that emits an x-ray beam 144. An object 146 being scanned is placed between the source 142 and an x-ray detector 148. In some embodiments, the object can be, for example, a triple-tray physical dental impression or any other type of physical dental impression. In some embodiments, for example, any other type of physical dental impression can be scanned. In some embodiments, the object can be any object that can, for example, fit in a CT scanning system and be penetrated by x-rays. The x-ray detector 148, in turn, is connected to a processing system 150 that is configured to receive the information from the detector 148 and to convert the information into a radiograph. Those skilled in the art will recognize that the processing system 150 may comprise one or more processors and/or computers that may be directly connected to the detector, wirelessly connected, connected via a network, or otherwise in direct or indirect communication with the detector 148 and/or with the CT scanning system 140.

An example of a suitable scanning system 140 includes a Nikon Model XTH 255 CT Scanner (Metrology) which is commercially available from Nikon Corporation. The example scanning system includes a 225 kV microfocus x-ray source with a 3 μm focal spot size to provide high performance image acquisition and volume processing. The processing system 150 may include a storage medium that is configured with instructions to manage the data collected by the scanning system. A particular scanning system is described for illustrative purposes; any type/brand of CT scanning system can be utilized.

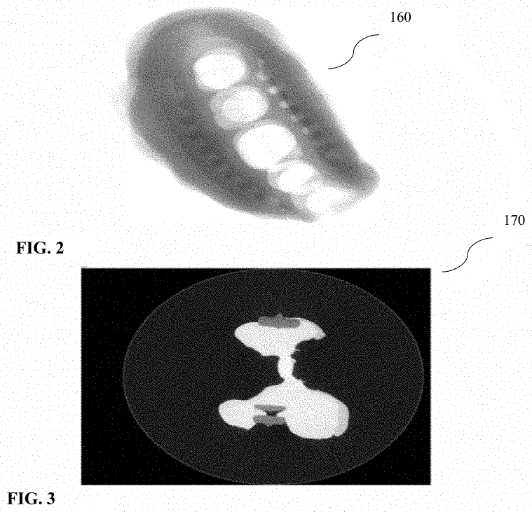

One example of CT scanning is described in U.S. Patent Application No. US20180132982A1 to Nikolskiy et al., the entirety of which is hereby incorporated by reference. As noted above, during operation of the scanning system 140, the object 146 is located between the x-ray source 142 and the x-ray detector 148. A series of images of the object 146 are collected by the processing system 150 as the object 146 is rotated in place between the source 142 and the detector 146. An example of a single radiograph 160 is shown in FIG. 2. The radiograph 160 and all radiographs described herein are understood to be digital. In one embodiment, a series of 720 images are collected as the object 146 is rotated in place between the source 142 and the detector 148. In other embodiments, more images or fewer images may be collected as will be understood by those skilled in the art.

Conventionally, the plurality of radiographs 160 of the object 146 are generated by and stored within a storage medium contained within the processing system 150 of the scanning system 140, where they may be used by software contained within the processor to perform additional operations. For example, in an embodiment, the plurality of radiographs 160 can undergo tomographic reconstruction in order to generate a 3D virtual image 170 (see FIG. 3) from the plurality of 2D radiographs 160 generated by the scanning system 140. In the embodiment shown in FIG. 3, the 3D virtual image 170 is in the form of a volumetric image or volumetric density file (shown in cross-section in FIG. 3) that is generated from the plurality of radiographs 160 by way of a CT reconstruction algorithm associated with the scanning system 140.

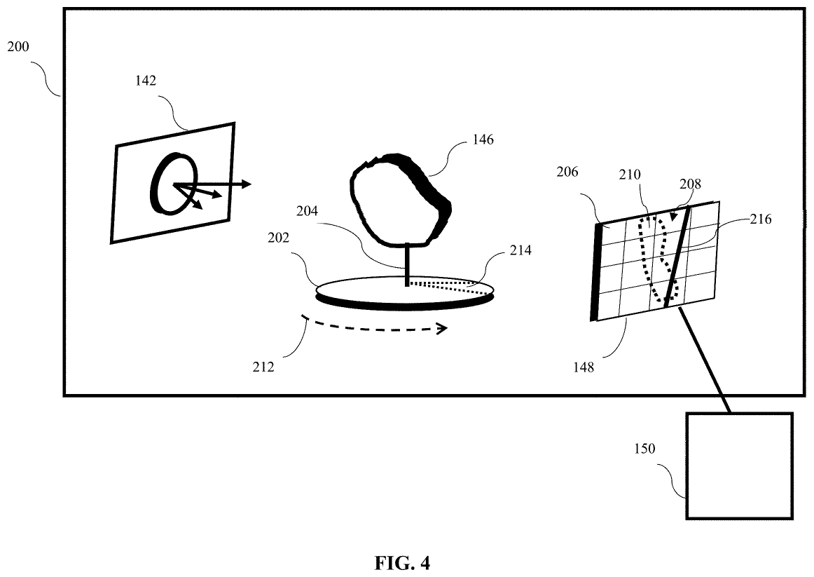

FIG. 4 is an illustration of portions of a CT scanning system as discussed previously. Certain features of the CT scanning system are not shown for clarity. Other conventional CT scanning systems known in the art can also be utilized. Conventionally, the physical object 146 to be scanned is placed inside the CT scanner 200 on a rotational platform 202 between an x-ray source 142 and x-ray detector 148. The physical object 146 is exposed to x-rays generated by the x-ray source 142 that travel from the x-ray source 142 through the physical object 146 and to the x-ray detector 148. The x-ray detector 148 conventionally includes a detector pixel array 206 (row of detector pixels and column of detector pixels) which detects any incident x-rays to generate a radiograph 208, for example. In some embodiments, the x-ray detector 148 can include an array resolution of 1,000×1,000 pixels, for example. In some embodiments, the number of pixels can be at least 1 million pixels, for example. Other numbers of pixels can also be present. Other array resolutions are also possible. Conventionally, as the physical object 146 is rotated around an axis of rotation 204, the x-ray detector 148 detects x-rays incident on each pixel such as detector pixel 210 (and any other detector pixels) at each rotational position to generate multiple radiographs. The x-ray detector 148 can detect a photon count at each pixel for each radiograph generated at each rotational position. In some embodiments, the possible photon count can be any value. In some embodiments, the possible photon count range can be anywhere from 0 to 65535 photons per pixel, for example. Other photon count ranges per pixel are also possible. In some embodiments, the physical object 146 can be rotated 360 degrees once, and the direction of rotation 212 can be either clockwise or counterclockwise. Conventional/standard CT scanning systems allow setting the total number of radiographs desired prior to scanning. Conventionally, the x-ray detector 148 detects and acquires a radiograph 208 every rotational degree 214 based on the total number of radiographs desired. For example, the rotational degree 214 can conventionally be determined as follows by the standard CT scanner 200: 360 degrees divided by the total number of radiographs, for example. In some embodiments, the total number of radiographs can be at least 500 radiographs, for example. The x-ray detector 148 conventionally detects and acquires the radiograph 208 as well as the photon count for every detector pixel such as detector pixel 210. An example of conventional photon counting and x-ray detectors can be found, for example, in Photon Counting and Energy Discriminating X-Ray Detectors-Benefits and Applications (David WALTER, Uwe ZSCHERPEL, Uwe EWERT, BAM Bundesanstalt für Materialforschung und-prüfung, Berlin, Germany, 19^{th} World Conference on Non-Destructive Testing, 2016), the entirety of which is hereby incorporated by reference. In some embodiments, the x-ray detector 148 can store the acquired radiographs. The axis of rotation 204 may not be visible, and is the axis around which the object rotates. A projection of a rotation axis 216 on the detector can be determined from one or more radiographs in some embodiments. The projection of the rotation axis 216 may not be visible in the radiograph.

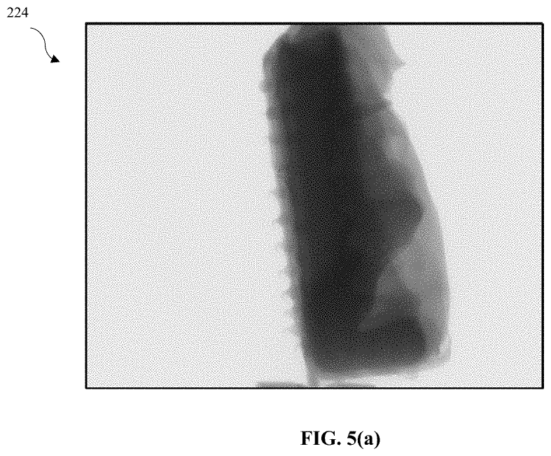

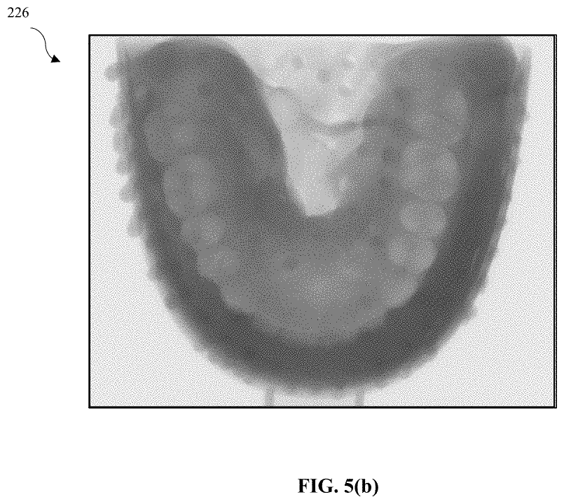

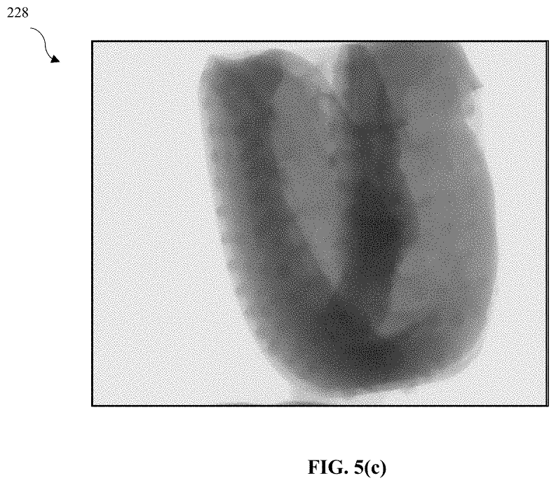

A single CT scan can therefore generate multiple radiographs in some embodiments in a single CT scan. FIGS. 5(a)-5(c) illustrate examples of a first radiograph 224, a second radiograph 226, and a third radiograph 228, respectively, of the multiple radiographs. Three radiographs are shown for illustration purposes only; the plurality of radiographs can include any number of radiographs, such as at least 500 radiographs, for example, in some embodiments. The first radiograph 224 can be the first radiograph pixels detected at a first rotational position, the second radiograph 226 can be the second radiograph pixels detected at a second rotational position, and the third radiograph 228 can be the third radiograph pixels detected at a third rotational position, for example. The nth radiograph can be the nth radiograph pixels detected at a nth rotational position as the physical object 146 is rotated around the axis of rotation 204 from zero to a fixed number of degrees such as 360 degrees, in some embodiments, for example. The number of radiograph pixels shown is also for illustration purposes only, and can be greater or smaller in value. In some embodiments, there can be 1,000 rows×1,000 columns of pixels, for example.

In some embodiments, the computer-implemented method can perform conventional CT reconstruction, which can include conventional filtering and conventional back-projection. One type of conventional CT reconstruction algorithm can be the filtered back projection algorithm as described in the Principles of Computerized Tomographic Imaging publication. For example, conventional CT reconstruction is also described in Held, Devin, Analysis of 3D Cone Beam CT Image Reconstruction Performance on a FPGA (2016), Electronic Thesis and Dissertation Repository, 4349, the entirety of which is hereby incorporated by reference. The conventional CT reconstruction algorithm can be referred to as the Feldkamp Reconstruction Algorithm, and is described in U.S. Pat. No. 5,375,156A to Kuo-Petravic et al., issued Dec. 20, 1994, the entirety of which is hereby incorporated by reference. Other types of CT reconstruction algorithms known in the art can also be used.

In some embodiments, the computer-implemented method can perform conventional filtering of the one or more radiographs received. Filtering conventionally involves applying a filtering function such as a ramp function or other type of filtering function known in the art to each row of the radiograph. Filtering is known in the art. For example, one or more filtering functions are described in FILTERING IN SPECT IMAGE RECONSTRUCTION, by Maria E. Lyra and Agapi Ploussi, Article in International Journal of Biomedical Imaging, Volume 2011, Article ID 693795, June 2011, the entirety of which is hereby incorporated by reference. In some embodiments filtering can include applying a filter function to the one or more radiograph rows to provide one or more filtered rows. Any type of CT reconstruction filtering function known in the art can be applied. In some embodiments, applying a filtering function can include convolving each row of the radiograph with the filter function to provide a filtered radiograph. In some embodiments, for example, a ramp filtering function can be applied. Any other filter known in the art can be applied in some embodiments, for example. In some embodiments, filtering is done per each row of the radiograph. In some embodiments, filtering is performed on the entire radiograph at once.

In some embodiments, the computer-implemented method can back-project one or more filtered radiographs using conventional back projection techniques known in the art. Back projection is conventionally known, and can include, in some embodiments, smearing back the one or more filtered radiographs on to the reconstruction volume. For example, in some embodiments, the smearing back is along the same rays joining in x-ray source position to hit detector pixels.

As an example, conventional back-projection can include the following steps. For each voxel of the volume being reconstructed, the computer-implemented method can determine a line that passes via the center of the voxel and the x-ray source point, considering that the x-ray source point changes location relative to the object with the rotation of the rotation table. The computer-implemented method can find a detector point where the line hits the detector. The computer-implemented method can take the value of the filtered image from this detector location and add it to the current voxel with an appropriate weight. The computer-implemented method can repeat the steps for all voxels and all projections.

For example, back-projecting for a cone-beam x-ray source is conventionally known as follows, which is back projecting a value that is bilineraly interpolated from a grid of Q_{β}(p, ξ):

g(t,s,z)=∫₀^{2π}(D²_{SO}/(D_{SO}−s)²)Q_{β}(D_{SO}t/(D_{SO}−s)),(D_{SO}z/(D_{SO}−s)))dβ

p=p′D_{SO}/D_{SO}+D_{DE}

ξ=ξ′D_{SO}/D_{SO}+D_{DE}

where (t,s,z) is the original coordinate system, D_{SO} is the source to rotation axis distance, D_{DE} is the rotation axis-to-detector distance, so the sum D_{SO}+D_{DE} is the distance from the source to the detector, and β is the angular differential change.

Other techniques for performing filtering and back projection known in the art can also be used by the computer-implemented method.

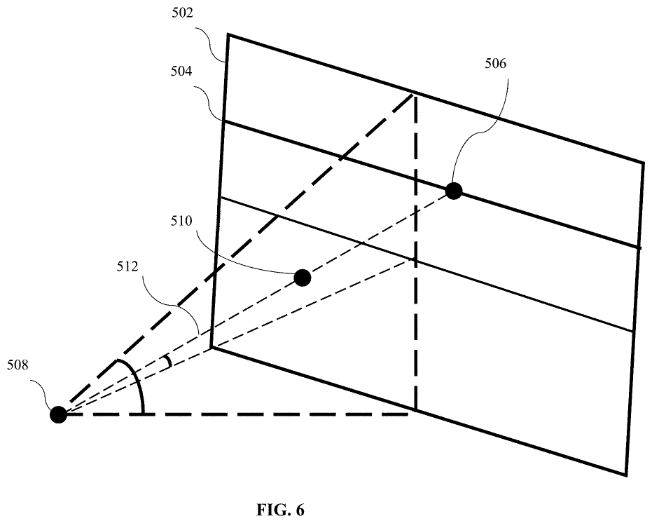

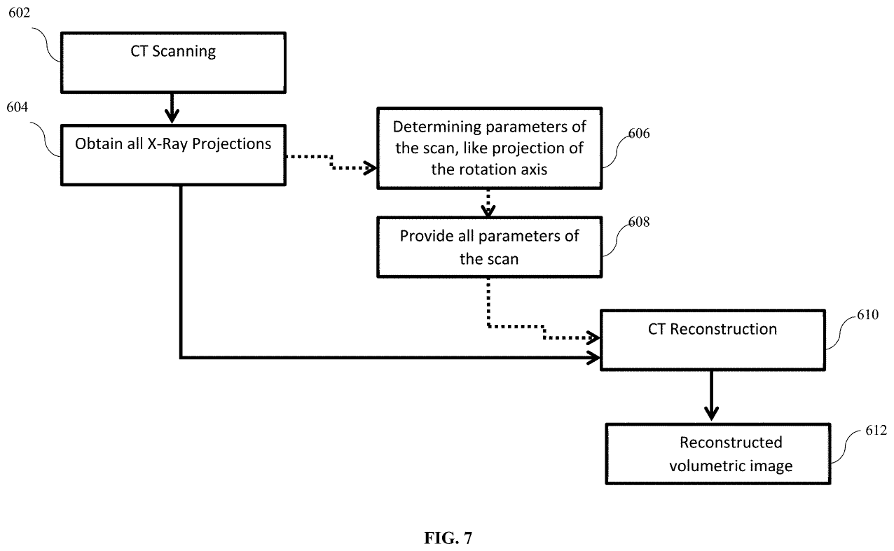

FIG. 6 illustrates an example of conventional filtered back projection, a detector 502 can include a filtered row 504. A detected point 506 can be back-projected to a source 508 through a voxel point 510 along line 512.

Conventional back projection can also utilize one or more geometric parameters of the scan to perform back projection. These parameters can include, for example, source-to-detector distance, source-to-rotation-axis distance, source vertical shift relative to detector center, and projection of the rotation axis on the detector (horizontal and inclination axis). In some embodiments, these parameters can be entered manually by a user. In some embodiments, one or more of the parameters can be determined as described in CT SCANNER CALIBRATION, U.S. patent application Ser. No. 16/887,437 of Nikolskiy et al., filed May 29, 2020, the entirety of which is hereby incorporated by reference. In some embodiments, the projection of the rotation axis on the detector can be determined as described in DETERMINING ROTATION AXIS FROM X-RAY RADIOGRAPHS, U.S. patent application Ser. No. 16/680,020 of Nikolskiy et al., filed Nov. 11, 2019, the entirety of which is hereby incorporated by reference.

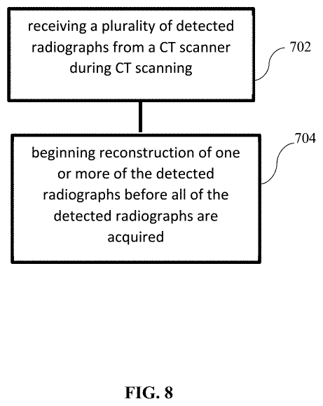

One example of a conventional CT scanning process is illustrated in FIG. 7. Conventional CT scanning can include performing CT scanning at 602 and obtaining all x-ray projections (radiographs) at 604. Once all x-ray projections are obtained, conventional CT scanning can perform CT reconstruction at 610 and provide the reconstructed volumetric image 612. Conventional CT scanning can optionally determine parameters of the scan, such as the projection of the rotation axis 606 and provide all parameters of the scan 608 to perform CT reconstruction 610. Conventional CT scanning can perform CT reconstruction only after scanning finishes and all radiographs have been acquired. The final reconstructed volumetric image may thus be available significantly after scanning finishes. This can occur even if the projection of the rotation axis on the detector does not change significantly from scan to scan.

In some embodiments, the computer-implemented method can include receiving a plurality of radiographs from a CT scanner during CT scanning and beginning reconstruction of one or more of the radiographs before all of the radiographs are acquired. In some embodiments, the computer-implemented method can receive the plurality of radiographs from the detector.

As illustrated in the example of FIG. 8, some embodiments of a computer-implemented method for CT reconstruction can include receiving a plurality of detected radiographs from a CT scanner during CT scanning at 702 and beginning reconstruction of one or more of the detected radiographs before all of the detected radiographs are acquired at 704.

As illustrated in the example of FIG. 4, a processing system 150 can communicate with and/or be connected to the CT scanner 200 and can receive the plurality of radiographs detected by the detector 148. In some embodiments, for example, the processing system 150 can be connected to the detector 148 to receive the plurality of radiographs such as the first radiograph 224, the second radiograph 226, the third radiograph 228 up to the nth radiograph. As an example, the computer-implemented method can begin CT reconstruction of the first radiograph 224 while the CT scanner is acquiring one or more additional radiographs such as the second radiograph 226 at the second rotational position, and/or the third radiograph 226 at the third rotational position, etc. In some embodiments, the computer-implemented method can continue performing CT reconstruction on one or more acquired radiographs as additional radiographs are being acquired by the CT scanner during CT scanning. In some embodiments, the computer-implemented method can perform CT reconstruction on multiple acquired radiographs in parallel or serially as the CT scanner is acquiring additional radiographs at additional rotational positions.

In some embodiments, the processing system 150 can turn on the x-ray source 142, activate detector 148, and send a command to start rotation of the table 202 object rotation. Each time the rotating table reaches every next expected position (e.g. 360 degrees/1000 in case of 1000 projection scan), a controller of the table can send the signal to detector to acquire the next radiograph. The computer-implemented method running on the processing system can receive the acquired radiograph from the detector and perform CT reconstruction even while other radiographs at other rotational positions are being acquired. In some embodiments, reconstruction of the radiograph is performed immediately after its acquisition. In some embodiments, reconstruction begins before scanning is complete. In some embodiments, reconstruction begins before all radiographs are received by the computer-implemented method. In some embodiments, CT scanning can include acquiring the one or more radiographs. Accordingly, in some embodiments, the computer-implemented method can construct the 3D volumetric image during scanning. In some embodiments, the computer-implemented method can begin reconstructing one or more radiographs before all radiographs are acquired by the CT scanner.

In some embodiments, beginning reconstruction of the one or more radiographs can occur during CT scanning. In some embodiments, reconstruction is performed during scanning. In some embodiments, reconstruction of each of the one or more radiographs is performed in the sequence received. In some embodiments, reconstruction of the one or more radiographs is performed serially. In some embodiments, reconstruction of radiographs is performed in parallel. In some embodiments, reconstruction of each of the one or more radiographs is performed upon receipt. In some embodiments, a reconstructed volume is available immediately after scanning of the object completes. In some embodiments, reconstruction is performed in parallel with scanning. In some embodiments, a radiograph is discarded after its reconstruction. In some embodiments, the radiograph is not stored in storage, such as disk storage.

In some embodiments, where the geometric parameters such as the rotation axis are determined from the radiographs as described in CT SCANNER CALIBRATION, U.S. patent application Ser. No. 16/887,437 to Nikolskiy et al and DETERMINING ROTATION AXIS FROM X-RAY RADIOGRAPHS, U.S. patent application Ser. No. 16/680,020 to Nikolskiy et al., the computer-implemented method can filter every acquired radiograph and then use it both to perform back projection reconstruction and optionally to determine the rotation axis as described in DETERMINING ROTATION AXIS FROM X-RAY RADIOGRAPHS cited previously. Since both back projection reconstruction and finding the rotation axis require filtering, the filtering stage can be shared and only performed once. In some embodiments, the radiograph can be immediately discarded. One or more advantages can include, for example, not having to retain the radiograph until the end of scanning or reconstruction, or determination of the projected rotation axis. At the end of scan a) reconstructed volumetric image of the scan and b) rotation axis can be found, and the projection of the axis of rotation can be used for the reconstruction of next scan in some embodiments for example.

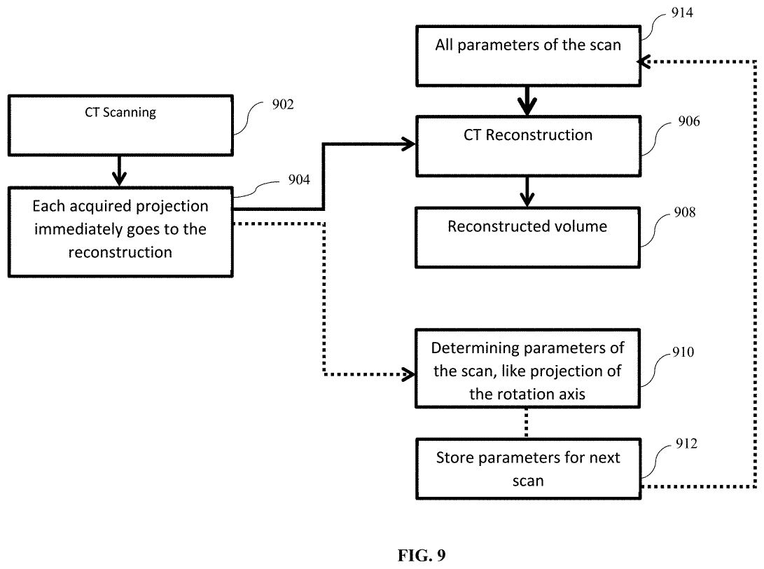

FIG. 9 illustrates an example in some embodiments of beginning reconstruction of the one or more radiographs before all radiographs are acquired. CT scanning starts at 902. In some embodiments, the computer-implemented method provides each acquired radiograph (radiograph) it receives immediately to reconstruction at 904. In some embodiments, the computer-implemented method performs CT reconstruction at 906 and generates the reconstructed volume at 908 as it receives each acquired radiograph. The computer-implemented method can optionally determine parameters of the scan such as the projection of the rotation axis at 910 and store the parameters for the next scan at 912. These parameters can be provided for the next CT scan as input to the CT reconstruction.

In some embodiments, once the scan finishes, the processing system 150 can turn off the x-ray source. In some embodiments, the reconstructed image generated by the computer-implemented method running on the computer is available. The computer-implemented method can optionally perform additional operations such as compressing the 3D volumetric image, storing the 3D volumetric image (or compressed 3D volumetric image) locally, on a network drive, sending it to a remote location such as a cloud computing environment, or perform other operations on the reconstructed image or the compressed reconstructed image. In some embodiments, the reconstructed image can also be referred to as a volumetric density file, or 3D volumetric image. In some embodiments, the CT scanning can finish before CT reconstruction and/or other operations such as determining geometric parameters are completed.

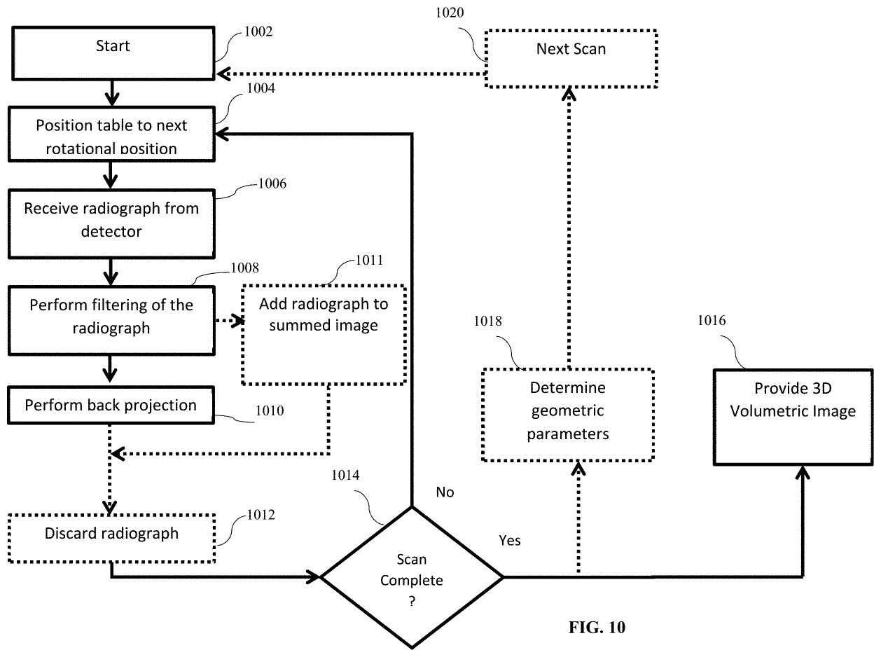

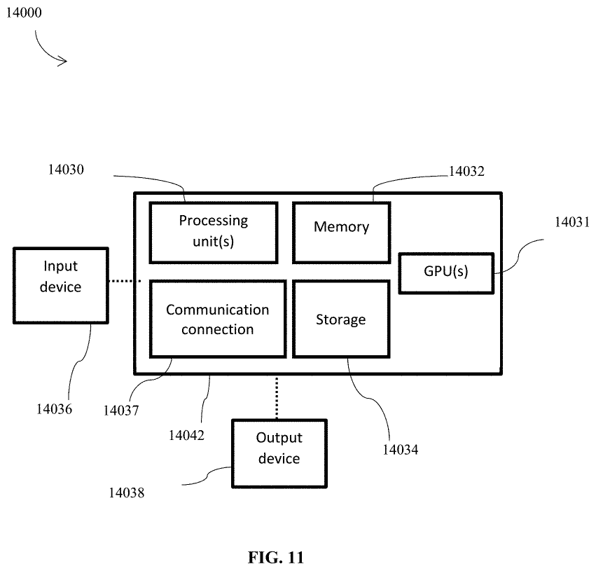

FIG. 10 illustrates an example in some embodiments of beginning reconstruction of the one or more radiographs before all radiographs are acquired. CT scanning can start at 1002. The rotation table can be positioned to the next rotational position at 1004. In some embodiments, this can be performed by the computer-implemented method or by another program issuing a command to the rotation table to rotate to the next position. In some embodiments, if this is the first radiograph to be acquired, the rotation table can be positioned at the first position. In some embodiments, the computer-implemented method can receive a radiograph from the detector at 1006 In some embodiments, the computer-implemented method can do this by issuing a command to the detector to take a radiograph and then receive the radiograph from the detector. In some embodiments, the computer-implemented method can perform conventional filtering known in the art of the radiograph at 1008. The computer-implemented method in some embodiments can optionally add the filtered radiograph to a filtered summed image for geometric parameter determination (such as rotation axis for example) at 1011. The filtered summed image can be a single image generated by adding the value of each pixel of the current filtered radiograph to the corresponding pixel in the filtered summed image, for example. In some embodiments, the computer-implemented method can perform conventionally known back projection at 1010. The computer-implemented method can optionally discard the radiograph at 1012.

The computer-implemented method can determine whether the scan is complete at 1014. If the scan is not complete, then the rotation table can be positioned to the next rotational position at 1004. If the scan is complete, the computer-implemented method can provide the 3D volumetric image at 1016.

Additionally, if the scan is complete, the computer-implemented method can optionally determine geometric parameters at 1018 from either the filtered summed image or from a filtered average image, which the computer-implemented method can determine by taking the values of each pixel in the filtered summed image and dividing by the total number of filtered radiographs. One or more of the geometric parameters can include, for example, the rotation axis and/or other parameters. In some embodiments, the computer-implemented method can optionally perform one or more features described in CT SCANNER CALIBRATION and/or in DETERMINING ROTATION AXIS FROM X-RAY RADIOGRAPHS, such as for example, determining the position of line symmetry in the filtered summed image or in the filtered average image and can determine the location of the projection of the axis of rotation and orientation by linear regression of the data from the filtered summed image or the filtered average image. Alternatively, in some embodiments, the computer-implemented method can optionally provide the filtered average image or the filtered summed image to another program that can determine the geometric parameters. The optionally determined geometric parameters can be optionally provided to the next scan at 1020.

In some embodiments, the computer-implemented method can receive and provide the one or more of the acquired radiographs to one or more graphics processing unit(s) (“GPU”) to perform the CT reconstruction. In some embodiments, the number of GPUs can be two, for example, although any suitable number of GPUs can be used. In some embodiments, each GPU can be part of a graphics card, as is known in the art. Accordingly, in some embodiments, one or more graphics cards can be used to perform the CT reconstruction.

In some embodiments, the computer-implemented method can retain the 3D volumetric image in memory of the processing system or the memory of the GPU without having to write the 3D volumetric image to storage, such as a hard disk as the GPU performs CT reconstruction of the one or more radiographs. Alternatively, in some embodiments, the computer-implemented method can write the 3D volumetric image to storage, such as a hard disk as the GPU performs CT reconstruction of the one or more radiographs.

One or more advantages of one or more features can include, for example, having the reconstructed volume available immediately at the end of scanning. One or more advantages of one or more features can include, for example, faster CT reconstruction of the reconstructed volume. One or more advantages of one or more features can include, for example, simultaneous CT reconstruction and CT scanning, thereby improving efficiency of CT scanning and CT reconstruction. One or more advantages of one or more features can include, for example, simultaneous CT reconstruction and CT scanning, thereby allowing more objects to be scanned and reconstructed in a given timeframe.

Some embodiments can include a non-transitory computer readable medium storing executable computer program instructions for performing CT reconstruction, the computer program instructions comprising instructions for receiving a plurality of radiographs and determining an axis of rotation per scan from the plurality of radiographs prior to CT reconstruction. In some embodiments, the non-transitory computer readable medium can include instructions to implement one or more features described in the present disclosure.

Some embodiments include a processing system for CT reconstruction that can include a processor, a computer-readable storage medium including instructions executable by the processor to perform steps including: receiving a plurality of detected radiographs from a CT scanner during CT scanning; and beginning reconstruction of one or more of the detected radiographs before all of the detected radiographs are acquired. In some embodiments, the processing system can include the processing system 150, for example.

FIG. 11 illustrates a processing system 14000 in some embodiments. The system 14000 can include a processor 14030, computer-readable storage medium 14034 having instructions executable by the processor to perform one or more steps described in the present disclosure. In some embodiments, the system can include instructions executable by the processor to perform one or more features described in the present disclosure. In some embodiments, the processing system 14000 can include one or more graphics processing units, wherein beginning reconstruction comprises the processor providing the one or more graphics processing units with the plurality of detected radiographs and instructions executable by the one or more graphics processing units to begin performing reconstruction of one or more of the detected radiographs before all of the detected radiographs are acquired.

One or more of the features disclosed herein can be performed and/or attained automatically, without manual or user intervention. One or more of the features disclosed herein can be performed by a computer-implemented method. The features—including but not limited to any methods and systems—disclosed may be implemented in computing systems. For example, the computing environment 14042 used to perform these functions can be any of a variety of computing devices (e.g., desktop computer, laptop computer, server computer, tablet computer, gaming system, mobile device, programmable automation controller, video card, etc.) that can be incorporated into a computing system comprising one or more computing devices. In some embodiments, the computing system may be a cloud-based computing system.

For example, a computing environment 14042 may include one or more processing units 14030, memory 14032, and one or more GPU(s) 14031. The processing units and the GPU(s) execute computer-executable instructions. A processing unit 14030 can be a central processing unit (CPU), a processor in an application-specific integrated circuit (ASIC), or any other type of processor. In some embodiments, the one or more processing units 14030 and/or the GPU(s) can execute multiple computer-executable instructions in parallel, for example. In a multi-processing system, multiple processing units execute computer-executable instructions to increase processing power. For example, a representative computing environment may include a central processing unit as well as a graphics processing unit or co-processing unit. The tangible memory 14032 may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

In some embodiments, the processing system can optionally connect with (for example through a direct wired connection, wireless connection, or a network connection) detector, x-ray source, and controller that can control rotation of rotation table. In some embodiments, the processing system can control turning the x-ray source off and on, rotation of the rotation table through a controller, and acquisition of the radiograph by the detector. In some embodiments, the one or more CPUs can, for example, communicate with a user through a user interface and communicate with one or more other computers such as those in a cloud computing environment, and can optionally communicate with one or more devices in the CT scanner such as the x-ray source, the detector, the controller, and/or the rotation table. In some embodiments, the one or more CPUs running the computer-implemented method can also receive the plurality of radiographs from the detector and the computer-implemented method can provide one or more of the plurality of radiographs to the one or more GPUs, for example to perform reconstruction. In some embodiments, the processing system can receive the radiographs immediately upon acquisition by the detector, for example.

In an alternative embodiment, the processing system can instead communicate with a second computer that is connected by wire or wirelessly to the detector, x-ray source, and controller. In such a case, the second computer can optionally operate the x-ray source, the controller, and receive radiographs from the detector. The processing system can communicate with the second computer over a network, for example. In the alternative embodiment, the computer-implemented method running on the processing system can receive the radiographs from the second computer.

In some embodiments, the computer-implemented method can utilize the one or more GPUs to perform CT reconstruction of the one or more radiographs using standard GPU frameworks known in the art, such as Compute Unified Device Architecture (“CUDA”) or Open Compute Language (“OpenCL”). The computer-implemented method can use other GPU frameworks known in the art as well. In some embodiments, the one or more GPU(s) 14031 can be integrated or can be part of one or more removable video cards (or graphics cards). In some embodiments, a suitable video card can be the Nvidia RTX 2080Ti, for example. Other suitable video cards/GPU types can be used. For example, any video card containing enough memory to retain the whole reconstruction volume without splitting the reconstructed volume into segments can be suitable.

A computing system may have additional features. For example, in some embodiments, the computing environment includes storage 14034, one or more input devices 14036, one or more output devices 14038, and one or more communication connections 14037. An interconnection mechanism such as a bus, controller, or network, interconnects the components of the computing environment. Typically, operating system software provides an operating environment for other software executing in the computing environment, and coordinates activities of the components of the computing environment.

The tangible storage 14034 may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage 14034 stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media 14034 (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers) (e.g., the computer-executable instructions cause one or more processors of a computer system to perform the method). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media 14034. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, Python, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosure may be applied, it should be recognized that the illustrated embodiments are only examples and should not be taken as limiting the scope of the disclosure.

What is claimed is:

1. A computer-implemented method for CT reconstruction, comprising:
receiving a plurality of detected radiographs from a CT scanner during CT scanning; and
beginning reconstruction of one or more of the detected radiographs before all of the detected radiographs are acquired.

2. The method of claim 1, wherein beginning reconstruction of the one or more radiographs is during CT scanning.

3. The method of claim 1, wherein CT scanning comprises acquiring the one or more radiographs.

4. The method of claim 1, wherein reconstruction is performed during scanning.

5. The method of claim 1, wherein reconstruction of each of the one or more radiographs is performed in the sequence received.

6. The method of claim 1, wherein reconstruction of each of the one or more radiographs is performed upon receipt.

7. The method of claim 1, wherein reconstruction of the radiograph is performed immediately after its acquisition.

8. The method of claim 1, wherein reconstruction begins before scanning is complete.

9. The method of claim 1, wherein reconstruction begins before all radiographs are received by the computer-implemented method.

10. The method of claim 1, wherein a reconstructed volume is available immediately after scanning of the object completes.

11. The method of claim 1, wherein reconstruction is performed in parallel with scanning.

12. The method of claim 1, wherein a radiograph is discarded after its reconstruction.

13. The method of claim 1, wherein CT reconstruction comprises filtering one or more of the plurality of detected radiographs and using the filtered radiographs to determine one or more geometric parameters.

14. A system for CT reconstruction, comprising:
a processor;
a computer-readable storage medium comprising instructions executable by the processor to perform steps comprising:
receiving a plurality of detected radiographs from a CT scanner during CT scanning; and
beginning reconstruction of one or more of the detected radiographs before all of the detected radiographs are acquired.

15. The system of claim 14, further comprising one or more graphics processing units, wherein beginning reconstruction comprises the processor providing the one or more graphics processing units with the plurality of detected radiographs and instructions executable by the one or more graphics processing units to begin performing reconstruction of one or more of the detected radiographs before all of the detected radiographs are acquired.

16. The system of claim 14, wherein beginning reconstruction of the one or more radiographs is during CT scanning.

17. The system of claim 14, wherein CT scanning comprises acquiring the one or more radiographs.

18. The system of claim 14, wherein reconstruction is performed during scanning.

19. The system of claim 14, wherein reconstruction of each of the one or more radiographs is performed in the sequence received.

20. The system of claim 14, wherein reconstruction of each of the one or more radiographs is upon receipt.

21. The system of claim 14, wherein reconstruction of the radiograph is performed immediately after its acquisitions.

22. The system of claim 14, wherein reconstruction begins before scanning is complete.

23. The system of claim 14, wherein reconstruction begins before all radiographs are received by the computer-implemented system.

24. The system of claim 14, wherein a reconstructed volume is available immediately after scanning of the object completes.
